(19) United States
(12) Patent Application Publication
(10) Pub. No.: US 2013/0105347 A1
(43) Pub. Date: May 2, 2013

(54) WAFER POCKET

(71) Applicants: Kathrin Reichardt, Berlin (DE); Sven Filler, Oranienburg (DE); Kirsten Gollin, Potsdam (DE)

(72) Inventors: Kathrin Reichardt, Berlin (DE); Sven Filler, Oranienburg (DE); Kirsten Gollin, Potsdam (DE)

(21) Appl. No.: 13/643,814

(22) PCT Filed: Apr. 28, 2011
(86) PCT No.: PCT/EP11/56789

§ 371 Date: Jan. 17, 2013

(30) Foreign Application Priority Data
Apr. 29, 2010 (DE) 10-2010-028.351.7

(51) Int. Cl. A61J 1/00

(52) U.S. Cl. CPC A61J 1/00
USPC 206/438; 206/524.2

(57) ABSTRACT

For the secure keeping of wafers 8 and for prevention of penetration and/or migration by an active ingredient present in the wafer 8 into the packaging material of a primary pack which serves to keep the wafer 8, and, furthermore, for the easy removal of the wafer 8 after the opening of the primary pack, a wafer sachet 1 as the primary pack is proposed, being formed by a layer construction of films, which comprises first and second sealing films 3, 4 which are connected to one another via at least one sealing region, so that between the first and second sealing films 3, 4 a cavity 7 is formed which is closed off to the outside and is suitable for receiving the wafer 8. In accordance with the invention, the layer construction further comprises at least one peeling film 2 which is connected to the first sealing film 3, which is intended for opening the wafer sachet 1, which is partly removable from the first sealing film 3 on opening of the wafer sachet 1, and which, when it is partly removed from the first sealing film 3, causes incisive tearing of the first sealing film 3 on further opening of the wafer sachet 1, so that the cavity 7 is opened to the outside.

The present invention relates to a wafer sachet which is formed by a layer construction of films. A wafer sachet of this kind is used preferably for receiving wafers, i.e., film plaques comprising active ingredients or other substances, these plaques comprising, for example, drugs for contraception or for hormone replacement therapy or else other drugs or other administration forms, examples being nicotine patches.

Wafer sachets of this kind serving as primary packaging have already been described:

DE 101 02 818 A1 discloses a primary packing unit for a plurality of isolated film plaques as administration forms—drugs, for example. This packaging has a bottom layer and a top layer, the top layer being sealed to the bottom layer. Formed between the bottom layer and the top layer are individual compartments, surrounded by sealing regions, for the administration forms. In the region of these compartments, the top and bottom layers are not sealed. In order to allow maximally close packing, especially for circular administration forms, the packaging has at least two rows of compartments, with the compartments and administration forms in adjacent rows having a staggered arrangement to one another. Assigned to the compartments for administration forms there may also be tongue-shaped regions of the top layer that are not sealed to the bottom layer, that project in each case into the intercompartmental spaces in the respective other row of compartments, and that, after the pack has been torn open along designated tearing lines, serve as grip tabs and tearing tabs. For this purpose, on their side facing each compartment, these tongue-shaped regions adjoin the designated tearing lines which are formed on both sides of the compartment in the top layer sealed to the bottom layer. Materials specified as suitable for the top and bottom layers are polyethylene (PE), polyethylene terephthalate (PET), polypropylene (PP), and ethylene-vinyl acetate copolymer (EVA). It is also possible, furthermore, to use paper, aluminum or assemblies of these materials. The top and bottom layers may consist of different materials.

DE 100 08 165 A1 describes primary packaging which comprises a bottom packing sheet and a top packing sheet, the packing sheets having regions in which they have intimate contact with one another. The regions enclose an inner region which is capable of receiving a sheetlike object. In order to allow the top packing sheet and the bottom packing sheet to be gripped separately and particularly easily, for the purpose of opening the primary packaging, and hence to allow the primary packaging to be opened conveniently, the top and bottom packing sheets each have at least one outer region, at the edge of the inner region, in which the packing sheets do not have contact with one another and do not lie congruently over one another—here, accordingly, there are regions in which there is only one of these packing sheets. As a result, each individual packing sheet can be gripped at its outer region by the thumb and index finger of each hand, in order to allow the intimate contact between the top and bottom packing sheets to be undone by pulling. The materials of the packing sheets may be, for example, polyethylene (PE), polyethylene terephthalate (PET), polypropylene (PP), OPA, polyacrylate (PA), EVOH, ethylene-vinyl acetate copolymer (EVA), EC, Barex, Surlyn, paper, aluminum, and combinations of these materials.

DE 10 2004 047 447 B4, further, discloses peelable, child-safe packaging for flat, flexible objects. The packaging has a base layer and an outer layer which is connected detachably to the base layer, the packaging having a first surface region, in which the base layer is not connected to the outer layer and which is fully surrounded by a marginal region, in which the base layer is connected detachably to the outer layer, thereby forming an omnilaterally enclosed cavity for receiving a stated object. In order to hinder or prevent unauthorized opening and withdrawal of the packaging's contents, the packaging also has a second surface region, in which the base layer is not connected to the outer layer, and in which there is at least one perforation line, the perforation line being made both in the base layer and in the outer layer. Severing the perforation produces a free edge on the outer layer, which serves as a gripping aid and allows the outer layer to be detached manually from the base layer. Materials stated for the base layer and the outer layer are packing materials comprising paper, cardboard, polymeric films, made from polyethylene, polyethylene terephthalate, polypropylene, polystyrene, cellophane, polyamides, polycarbonates, ethylene-vinyl acetate copolymer, and especially Barex, a copolymer of acrylonitrile and butadiene, for example, and also metallic foils, made from aluminum, for example, and also composites of the stated materials.

The known primary packaging forms for wafers, however, have the following disadvantages: for convenient withdrawal of a product from the sealed cavity of a wafer sachet, it is possible, admittedly, for the films forming the wafer sachet, the top film and the bottom film, to be partable from one another, allowing one film to be removed (peeled away) from the other. The only film materials available for this purpose, however, are materials which do not afford a sufficient barrier to the penetration or migration of active ingredients from the wafer or into the film—polyethylene, for example. Conversely, those inert materials that are sufficiently suitable as barriers to penetration or migration, such as Barex® (BP Chemicals), for example, cannot be parted from one another mechanically. As an alternative to the opening of a wafer sachet, admittedly, they can also be torn open, by incisive tearing of the films at the notched incision. But this achieves only unilateral opening of the cavity in which the wafer is located, and so the wafer cannot be easily grasped.

The object on which the present invention is based, therefore, is that of providing primary packaging for wafers that on the one hand ensures secure preservation of the wafers, and more particularly prevents substantial penetration or migration into the product or into the packaging material of the auxiliaries or else the active ingredient or ingredients present in the wafer, and on the other hand provides for simple withdrawal of the wafer after the primary packaging has been opened.

These objects are achieved by the wafer sachet according to claim 1. Preferred embodiments of the invention are specified in the dependent claims.

Where the term “wafer” is used in this description and in the claims, it refers to a flat, flexible object or film plaque which comprises at least one active ingredient, more particularly an active medicinal ingredient. Wafers of these kinds are used typically for administering the active ingredient or ingredients to a human or animal body, with a wafer comprising this or these active ingredient or ingredients and being contacted, for administration, with a part of the body of the individual to which or to whom the active ingredient or ingredients is or are being administered. For example, an active ingredient may be a contraceptive or an agent for hormone replacement therapy or else another medicinal product, or a different active ingredient such as an active ingredient of a nicotine patch, for example, or an auxiliary, such as a flavor. The wafer consists typically of a matrix which breaks down on administration and delivers the active ingredient or ingredients to the oral cavity.

Where this description and the claims use the terms ‘connection’, ‘connecting . . . ’, ‘connect’, and ‘connected’, the reference is to an areal, linear or at least punctiform fusional connection. As examples, the partners may be connected to one another by means of cold or hot sealing or welded connection. Other possibilities are adhesive connections, although they are generally not advantageous under production conditions.

The wafer sachet of the invention is formed by a layer construction of films and comprises first and second sealing films, connected to one another over at least one sealing region, so that between the first and second sealing films a cavity is formed which is closed off to the outside and is suitable for receiving a wafer. In accordance with the invention, the layer construction further comprises at least one peeling film which is connected to the first sealing film, which is intended for opening the wafer sachet, which is at least partly removable from the first sealing film on opening of the wafer sachet, and which, when it is partly removed from the first sealing film, causes incisive tearing of the first sealing film on further opening of the wafer sachet. As a result, the cavity formed by the two sealing films is opened to the outside. This prevents the product being wholly or partly torn.

In one particularly preferred embodiment of the invention, the wafer sachet of the invention contains a wafer.

Since the sealing films forming the cavity need not necessarily consist of materials which can be parted from one another, it is possible, at least on the sides of the sealing films that point toward the cavity, to use an inert material which is largely resistant to penetration of active ingredient or migration of the active ingredient into the material and which therefore forms a barrier with respect to the active ingredient. For this purpose, Barex® (BP Chemicals), a copolymer of acrylonitrile and butadiene, has proven suitable. The material in question may in general be one which does not readily allow films bearing against one another to be removable. Consequently, therefore, the requirement for minimal interaction between product and film material for the film that forms the cavity in the wafer sachet is not also subjected to the further requirement that the two sealing films can be separated (removed) from one another mechanically in order to allow the wafer to be removed from the wafer sachet without problems and with good handling qualities. Hence there is a relatively large degree of freedom in the selection of the material for the sealing films, at least in respect of the side that is in contact with the cavity, thus allowing an optimum selection to be made in respect, among other factors, of the costs and the environmental compatibility of the material.

Since, furthermore, an additional peeling film is provided which, as soon as it has been partly removed from the first sealing film, causes incisive tearing of the first sealing film on further opening of the wafer sachet, the wafer sachet becomes openable in a way after which the wafer can be removed very easily from the wafer sachet. The removal of the peeling film from the first sealing film, and the further removal and hence tearing of the first sealing film, allows the first sealing film to undergo incisive tearing in such as way that the wafer in the cavity is exposed and hence can be withdrawn without problems.

In order to allow the peeling film to be removed from the first sealing film, the peeling film and the first sealing film may each be connected to one another preferably via layers of material which possess good sealability—layers of polyethylene, for example.

In one preferred embodiment of the invention, the first sealing film is provided with at least one incision, which, for example, lies substantially transverse to the pulling direction, outside a region which is formed by the cavity between the sealing films. An incision in the present context means a pertusion through the first sealing film. This incision, on both sides at its ends, preferably further comprises incision sections which run substantially parallel to the pulling direction, within the region formed by the cavity between the sealing films. As a result, the first sealing film, starting from the at least one incision, undergoes incisive tearing when the wafer sachet is opened further in an opening direction (pulling direction), and opens the cavity for the manual removal of the wafer.

In one particularly preferred embodiment of the invention, the wafer sachet, starting from two ends of the at least one incision, undergoes incisive tearing in the opening direction, thereby exposing the wafer in the cavity.

In a further-preferred embodiment of the invention, the first sealing film has two incisions oriented to one another in roof format, and located within the region of the cavity. In the first sealing film, accordingly, these incisions are made at an angle >0° and more particularly >90°, but <180°, to one another. They preferably transition directly into one another—that is, there is preferably no interruption between the two incisions, and so these two incisions together may also be considered as a single, dogleg incision.

The two incisions are preferably made into the first sealing film in such a way that the angle formed by the two incisions opens in the direction in which the peeling film removes the first sealing film (opening direction). The ends of the incisions remote from the connection of the two incisions extend up to the edges of the wafer sachet, transversely to the opening direction, and dogleg at the end in the opening direction.

As a result of the two stated incisions in the first sealing film, the peeling film, on removal, is able to bring about incisive tearing of the first sealing film, starting from these incisions. A particular help here are the incision sections that are provided at the ends of each of the incisions and that extend parallel to the opening direction. When the peeling film has first been removed, over a partial section, from the first sealing film, it is no longer removed from the first sealing film on further opening of the wafer sachet, but instead lifts it in the region of the cavity from the second sealing film, by virtue of the first sealing film undergoing incisive tearing, starting from the incisions. For this purpose, the peeling film and the first sealing film are connected to one another in at least one connecting region, the connecting region extending at least over the cavity and the at least one incision. Indeed, as a result of the fact that the at least one incision is located in the connecting region, the incisions are masked by the peeling film and sealed off securely from the outside space for as long as the peeling film is not removed from the first sealing film and hence the wafer sachet is still closed. The region in which the cavity for the wafer is located is also masked by the connecting region between the peeling film and the first sealing film, and so, on opening of the wafer sachet, in the region of the cavity, the peeling film lifts the first sealing film from the second sealing film, by incisive tearing of the first sealing film, and hence provides access to the wafer for its removal. Moreover, in the connecting region, as a result of the nature of the inner layer, the adhesion force between the peeling film and the first sealing film is preferably lower than the adhesion force between the first sealing film and the second sealing film. As a result of this, the peeling film can be detached from the first sealing film in a region in which it is removed before the incision is attained during removal.

In a further preferred embodiment of the invention, the peeling film and the first sealing film, adjacently to the connection region between the first sealing film and the peeling film, form a grip and opening tab. With this it is possible to grasp the peeling film, for example, by the thumb and index finger of one hand, and to grasp the first sealing film, for example, by the thumb and index finger of the other hand, and to pull the two apart, in order to open the wafer sachet in a manner in accordance with the invention. Preferably, furthermore, the first and second sealing films are also connected to one another in this region. In that case the first and second sealing films together form one part of the grip and opening tab, and the peeling film forms the other part, allowing the first and second sealing films together to be grasped by one hand and the peeling film to be grasped by the other hand, in order for the two parts to be pulled apart for the purpose of opening the wafer sachet.

In one preferred embodiment of the invention, a region which forms the grip and opening tab of the first sealing film adjoins the connecting region via a bordering line designed in a roof format, the connecting region tapering in a direction opposite to the opening direction when the wafer sachet is opened. This facilitates the removal of the peeling film from the first sealing film, since initially it is necessary only to separate a narrow part of the connecting region, which then, however, becomes increasingly wide. However, it is also possible for the bordering line to run linearly and preferably transverse to the opening direction.

In a further preferred embodiment of the invention, the peeling film and the first and second sealing films each adjoin tear-off sections via a region which forms the grip and opening tab. The tear-off sections are removable from the peeling film and/or from the first sealing film and/or from the second sealing film. By way of the tear-off sections, the wafer sachets can be accommodated in stacked formation in a secondary packaging, with the tear-off sections being held in the secondary packaging. By virtue of the fact that the tear-off sections are separable from the respective main part of the films, by tearing, for example, the wafer sachets may be taken out individually from the secondary packaging. The separability of the respective films from the tear-off sections may be realized, for example, by way of perforation.

In a further preferred embodiment of the invention, the tear-off sections may have a shaping such that they can be received into a holding unit in a secondary packaging. For example, the holding unit may partly enclose the tear-off sections, so that the tear-off sections are connected to the wafer sachets only via respective connecting regions which have, for example, the perforation. Alternatively, within the tear-off sections, there may be recesses, flush with one another, for receiving a holding element which traverses the recesses. Each of these embodiments holds the wafer sachets in the secondary packaging.

Furthermore, the at least one sealing region may omnilaterally adjoin the respective margin of the first and second sealing films.

It is particularly preferred if the first and second sealing films and also the peeling film are each formed of a laminate of interconnected plies, in order to achieve optimum construction of the laminate with regard to the compatibility of the particular film with the wafer, the handling qualities of the wafer sachet, during opening, for example, the external design, for external printing, for example, and further, drug-specific requirements.

For this reason, in one particularly preferred embodiment of the invention, the first sealing film comprises on one side preferably a chemically inert ply, as for example a Barex® ply, and on another side a readily sealable ply, as for example a polyethylene ply. The chemically inert ply faces the cavity for the wafer, and the readily sealable ply faces the peeling film. This results on the one hand in chemical inertness of the first sealing film with respect to the wafer, and on the other hand in removability (peelability) of the peeling film from the first sealing film. Both layers of the first sealing film are preferably connected to one another via a barrier foil, made of aluminum, for example, in order to protect the product from drying out or loss of aroma, for example, and with respect to external influences.

Moreover, at the respective sides facing outward, the second sealing film and the peeling film may each have a printable polymer ply, in order to allow the wafer sachet to be provided with an imprint. The printable polymer ply of the second sealing film and the printable polymer ply of the peeling film may more particularly consist of polyethylene terephthalate.

The chemically inert ply and the printable polymer ply of the second sealing film may advantageously be connected to one another via a barrier foil, made from aluminum laminate, for example, and the sealable ply and the printable polymer ply of the peeling film may likewise be connected to one another via a barrier foil, again made, for example, of aluminum laminate. This barrier likewise serves for protection of the product.

Further illustration of the invention is aided by the figures elucidated below.

FIG. 1 shows a perspective view of a wafer sachet of the invention, with an illustration of the peeling film, the first sealing film, and the second sealing film;

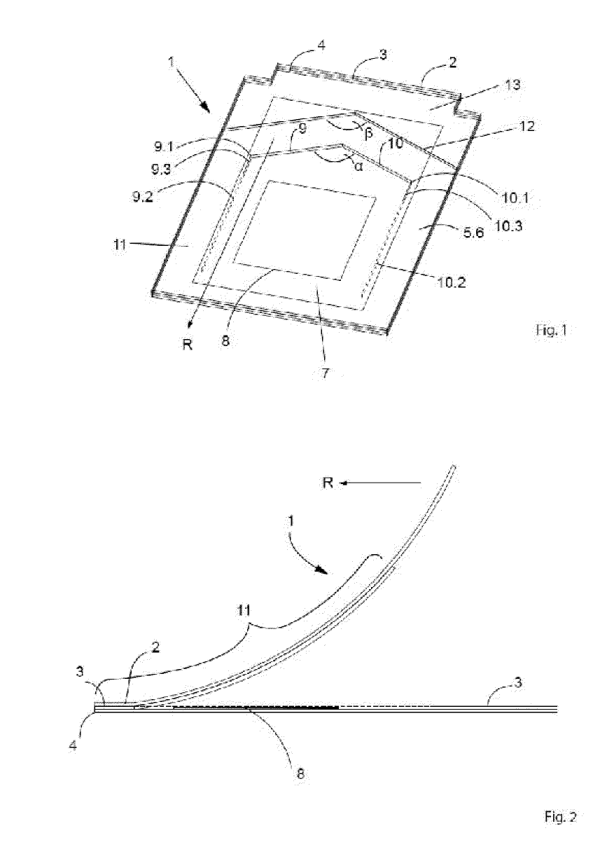

FIG. 2 shows a sectional view of the wafer sachet of the invention from the side, the peeling film having been pulled off upward to open the wafer sachet;

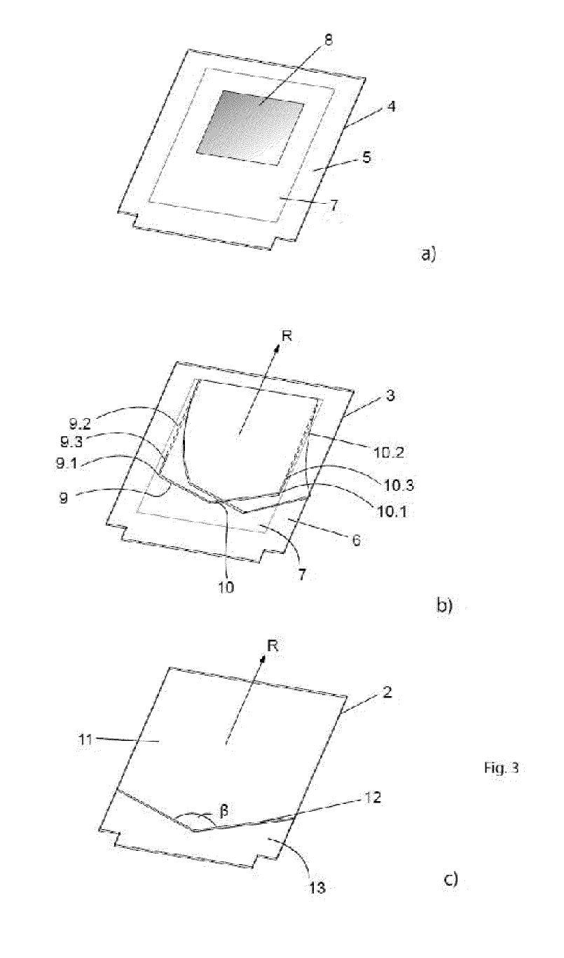

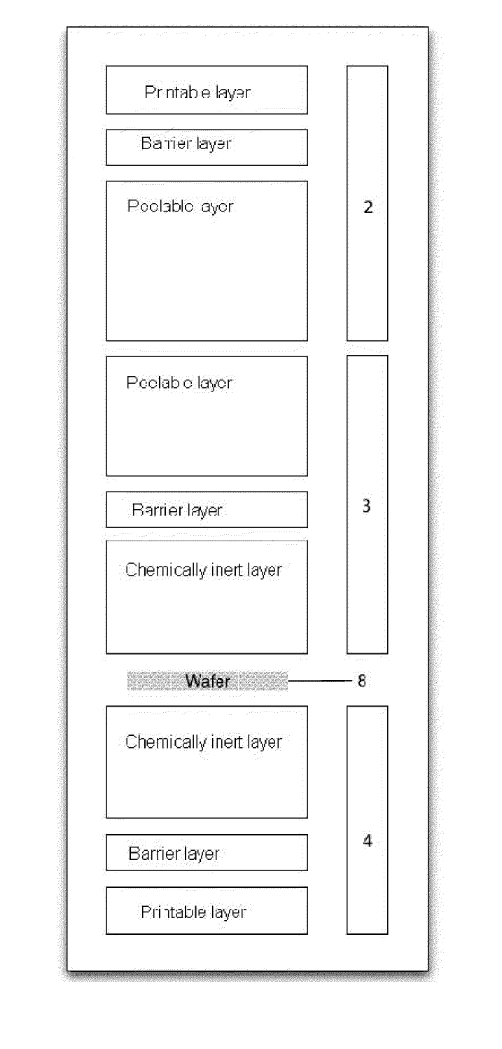

FIG. 3 shows perspective views of the individual films of a wafer sachet: a) a second sealing film; b) a first sealing film; c) a peeling film;

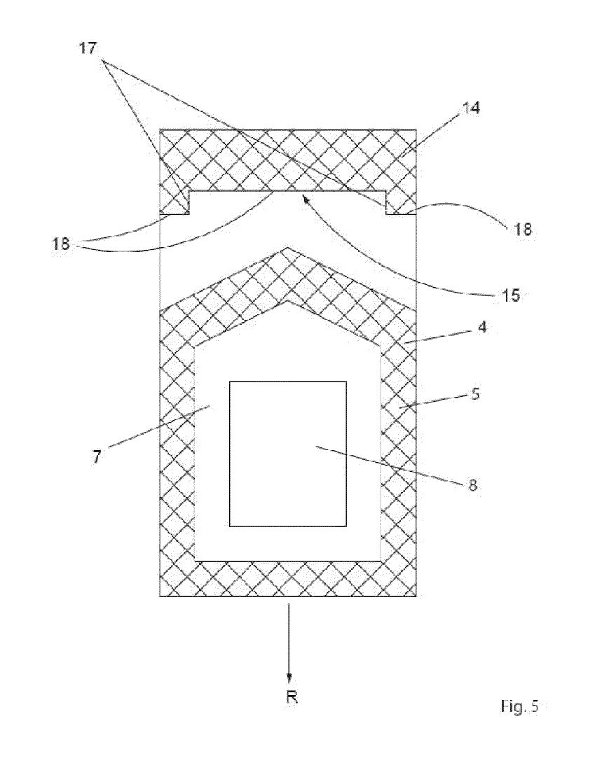

FIG. 4 shows diagrammatically a typical construction of the three films of the wafer sachet of the invention;

FIG. 5 shows a view of a second sealing film of a wafer sachet, with a tear-off section adjoining it.

Identical reference characters in the figures denote identical elements.

The wafer sachet 1 is shown in FIG. 1 in a perspective view and in FIG. 2 in a sectional view from the side, with FIG. 1 showing the layer construction of the wafer sachet 1 in the closed state, and FIG. 2 showing the opened wafer sachet 1.

In FIG. 3 the peeling film 2 (FIG. 3c), the first sealing film 3 (FIG. 3b), and the second sealing film 4 (FIG. 3a) are illustrated perspectively, in each case individually. The three films 2, 3, and 4 have the same shape and size, and so lie congruently on one another when laid over one another.

From FIG. 1 and FIG. 2 it is apparent that the wafer sachet 1 consists of three films, which are at least partly connected to one another to form a laminate: a peeling film 2, illustrated as the topmost film in FIGS. 1 and 2; a first sealing film 3, illustrated as the middle film in FIGS. 1 and 2; and a second sealing film 4, illustrated as the bottom film in FIGS. 1 and 2. In FIG. 3 these three films are each shown individually.

The second sealing film 4 has an outer sealing edge 5 via which the second sealing film 4 is connected to the first sealing film 3. Accordingly, the first sealing film 3 as well has a sealing edge 6 in a region which is congruent with the corresponding region on the second sealing film 4. This is easy to make out in FIG. 3. For example, the first sealing film 3 is connected to the second sealing film 4 via these sealing edges 5 and 6 by means of a sealing process. Connecting the first sealing film 3 to the second sealing film 4 via these sealing edges 5 and 6 produces a cavity 7 in which there is a wafer 8. To the extent that the wafer 8 does not fully fill the cavity 7, air is present within this cavity 7. At the sides adjacent to the cavity 7, the first sealing film 3 and the second sealing film 4 consist of a chemically inert material—Barex®, for example—in order to rule out the possibility of the active ingredient present in the wafer 8, a contraceptive, for example, penetrating the material of the two films 3 and 4.

In the first sealing film 3, furthermore, there are two incisions made, 9 and 10, which transition into one another, in the middle, and are arranged in the shape of a roof relative to one another. At each of the outwardly pointing ends 9.1, 10.1 of the incisions, they dogleg into the pulling/opening direction R. The resultant incision sections 9.3 and 10.3 serve to allow controlled incisive tearing of the first sealing film in the pulling direction until the beginning of the edge sealing. The two incisions 9 and 10 are situated within a region which is defined by the cavity 7. Their ends and incision sections therefore end likewise within this region. The two incisions 9 and 10 are arranged at an angle α>90° and α<180° to one another. The angle α included between them opens to form the cavity 7 for the wafer 8.

The peeling film 2 is partly connected to the first sealing film 3 in a connecting region 11. Starting from a bordering line 12, this connecting region 11 extends over the region occupied by the cavity 7 for the wafer 8, and also, in part, over the regions occupied by the sealing edges 5 and 6. The bordering line 12 is designed in the form of a roof. The connecting region 11 consequently widens in the direction of the region comprising the cavity 7.

On the other side of the bordering line 12, in a region 13 which forms a grip and opening tab, the peeling film 2 and the first sealing film 3 are not connected to one another. In this region 13, however, the first sealing film 3 and the second sealing film 4 are partly connected to one another, specifically via the sealing edges 5 and 6. If the wafer sachet 1 is to be opened, the user can hold the peeling film 2, in the region 13 in which it is not connected to the first sealing film 3, by the thumb and index finger of one hand, and can hold the first sealing film 3 and the second sealing film 4, in the same region 13, with the thumb and index finger of the other hand, and then can pull the two held sections apart. This region 13 in the peeling film 2 and in the laminate made up of the first sealing film 3 and the second sealing film 4 therefore forms a grip and opening tab via which the wafer sachet 1 can be opened.

For the opening of the wafer sachet 1, the peeling film 2, on the one hand, and the laminate made up of the first sealing film 3 and the second sealing film 4, are pulled manually apart in an opening direction R, so that initially a part of the connecting region 11 is parted, i.e., in this region 11, the peeling film 2 is partly removed from the first sealing film 3. For this purpose, the peeling film 2 and the first sealing film 3, at the sides bearing against one another, consist preferably of a readily peelable layer, of polyethylene, for example, which is suitable for allowing two films consisting thereof to be separated from one another manually, easily, with expenditure of not too great a force. To this end, the adhesion force between the peeling film and the first sealing film in the connecting region is lower, owing for example to the film construction of the sealing film, than the adhesion force between the first sealing film and the second sealing film in the sealing regions 5 and 6. By virtue of the fact that the bordering line 12, which delimits the connecting region 11 from the region 13 of the grip and opening tab, forms an angle β which opens in the opening direction R, the peeling film 2 can be removed relatively easily from the first sealing film 3. In principle, however, the bordering line 12 may also run straight and preferably perpendicular to the opening direction R.

As soon as the peeling film 2 has been removed from the first sealing film 3 to an extent such that the remaining connecting region 11 extends up to the incisions 9 and 10, i.e., the bordering line, now shifted, reaches the incisions 9 and 10, the peeling film 2 lifts the first sealing film 3 off and no longer releases itself from this film 3. This comes about by virtue of the fact that the force which is needed to produce incisive tearing into the first sealing film is lower than the adhesion force between the peeling film and the first sealing film. As soon as the remaining connecting region then extends just up to the ends 9.1 and 10.1 of the incisions 9 and 10, the first sealing film 3 undergoes tearing under the application of force via the peeling film 2, preferably in the opening direction R, and in fact does so starting from the ends 9.1 and 10.1 of the incisions 9 and 10, by way of the incision sections 9.3 and 10.3, which dictate the direction of the incisive tearing. Tearing lines 9.2 and 10.2 are therefore formed which extend substantially parallel to the opening direction R and in that direction R. Because the ends 9.1 and 10.1 of the incisions 9 and 10 and the incision sections 9.3 and 10.3 are situated within the region which is encompassed by the cavity 7, the tearing lines 9.2 and 10.2 which form also run within this region. As a result, when the peeling film 2 is removed, the cavity 7 is gradually opened, allowing the wafer 8 to be withdrawn from the cavity 7 without any problems.

FIG. 3b shows how the first sealing film 3 has been torn open under the effect of the peeling film 2, along the tearing lines 9.2 and 10.2. FIG. 2, moreover, shows the entire laminate after tearing: the upper peeling film 2 has lifted the first sealing film 3 along with it during opening of the wafer sachet 1, thereby exposing the wafer 8 in the cavity 7. The first sealing film 3 in the as yet unopened position is also shown with dashes in FIG. 2.

Shown diagrammatically in FIG. 4 is a typical construction of the laminate of a wafer sachet 1 of the invention with a wafer 8 contained within it. The three films—the peeling film 2, the first sealing film 3, and the second sealing film 4—are each formed by three plies, as illustrated at the side in FIG. 4:

On the top face, the peeling film 2 consists of a ply of readily printable polymer, such as of polyethylene terephthalate (PET), for example, thus allowing an imprint to be applied to the top face of the wafer sachet 1, for the purpose, for instance, of identifying the drug, the manufacturer, the expiry date, a registration symbol and/or other symbols. On the bottom face, furthermore, the peeling film 2 comprises a ply of readily peelable material, such as of polyethylene (PE), for example, which allows the peeling film 2 to be peeled off partly from the first sealing film 3. Located between these two plies is a barrier layer, made of aluminum (Al), for example, which acts as a moisture barrier.

The first sealing film 3, on the side facing the peeling film 2, likewise comprises a ply of readily peelable material, such as of polyethylene (PE), for example, thus allowing the peeling film 2 to be easily removed manually from the first sealing film 3. On the side facing the cavity 7 for the wafer 8 there is a chemically inert ply, made of Barex®, for example. However, this ply cannot be readily removed from the corresponding chemically inert ply of the second sealing film. Located between the chemically inert ply and the readily peelable ply of the second sealing film, again, is a barrier ply, such as an aluminum ply (Al), for example.

On the side facing the first sealing film, the second sealing film 4 likewise comprises a chemically inert ply, a Barex ply, for example, so that active ingredients from the wafer 8 cannot reach the second sealing film 4 either. On the bottom face there is a ply of readily printable material, made of polyethylene terephthalate (PET), for example, which may be provided with the same details as or different details from the peeling film 2. Located between the chemically inert ply and the printable ply, again, is a barrier ply.

Illustrated in FIG. 5 is a second sealing film 4 in a different embodiment, with a tear-off section 14. The second sealing film 4 and the tear-off section 14 adjoin one another via a parting line 15. In the same way, the peeling film 2 and the first sealing film 3 also transition into corresponding tear-off sections 14. In the region of the tear-off sections 14, the films are each connected to one another. Only through the removal of the wafer sachet 1 that is formed by the peeling film 2, the first sealing film 3, and the second sealing film 4 is the grip and opening tab formed, which can be used to pull the films apart. The second sealing film 4 shown in FIG. 5 has the sealing edge 5 which is connected to the corresponding sealing edge of the first sealing film 3 and thereby forms the cavity 7 in which the wafer 8 is located.

The tear-off section 14 is suitable for being received into a holding unit which is located in a secondary packaging, in which the wafer sachets 1 are accommodated in stacked form. For this purpose, the tear-off sections 14 of the individual films and wafer sachets 1 are flush. In the assembled state, the holding unit engages around the end face of the tear-off sections, around the narrow sides of the tear-off sections, and also in the region of the incisions 18, whereas the holding block does not engage around the tear-off sections in the middle region of the parting line 15, allowing them to be in connection with the respective wafer sachet via this region.

The parting line 15 may consist at least partly of a perforation. In the present example there are two perforation sections 17. The other sections of the parting line 15 are formed by incisions 18. On tearing, therefore, the wafer sachet 1 can be easily torn from the secondary packaging in the direction R. After the wafer sachet 1 has been torn off, the grip and opening tab is functionally ready, and so the wafer sachet 1 can be opened.

1. A wafer sachet (1) formed by a layer construction of films, comprising first and second sealing films (3, 4) connected to one another via at least one sealing region, so that between the first and second sealing films (3, 4) a cavity (7) is formed which is closed off to the outside and is suitable for receiving a wafer (8),
characterized in that the layer construction further comprises at least one peeling film (2) which is connected to the first sealing film (3), which is intended for opening the wafer sachet (1), which is partly removable from the first sealing film (3) on opening of the wafer sachet (1), and which, when it has been partly removed from the first sealing film (3), causes incisive tearing of the first sealing film (3) on further opening of the wafer sachet (1), so that the cavity (7) is opened to the outside.

2. The wafer sachet (1) of claim 1, characterized in that the first sealing film (3) is provided with at least one incision (9, 10) outside a region formed by the cavity (7), so that the first sealing film (3), starting from the at least one incision (9, 10), undergoes incisive tearing on further opening of the wafer sachet (1) in an opening direction (R) in a region of the cavity (7).

3. The wafer sachet (1) of claim 2, characterized in that the wafer sachet (1) undergoes incisive tearing starting from two ends (9.1, 10.1) of the at least one incision (9, 10) in the opening direction (R), so that the wafer (8) in the cavity (7) is exposed.

4. The wafer sachet (1) of claim 3, characterized in that incision sections (9.3, 10.3) extending in the opening direction (R) abut the ends (9.1, 10.1) of the at least one incision (9, 10).

5. The wafer sachet (1) of claim 1, characterized in that the first sealing film (3) has two incisions (9, 10) oriented to one another in a roof format, or one straight incision which runs preferably perpendicular to the opening direction (R), said incisions or incision being located within the region of the cavity (7).

6. The wafer sachet (1) of claim 1, characterized in that the peeling film (2) and the first sealing film (3) are connected to one another at least in a connecting region (11), the connecting region (11) extending at least over the cavity (7) and the at least one incision (9, 10).

7. The wafer sachet (1) of claim 6, characterized in that the peeling film (2) and the first sealing film (3), adjacently to the connecting region (11) between the first sealing film (3) and the peeling film (2), to form a grip tab.

8. The wafer sachet (1) of claim 7, characterized in that a region (13) of the first sealing film (3) that forms the grip tab adjoins the connecting region (11) via a boundary line (12) designed in roof format, the connecting region (11) tapering in a direction counter to the opening direction (R) on opening of the wafer sachet (1).

9. The wafer sachet (1) of claim 7, characterized in that a region (13) of the first sealing film (3) that forms the grip tab adjoins the connecting region (11) via a linear boundary line (12).

10. The wafer sachet (1) of claim 7, characterized in that the peeling film (2) and the first and second sealing films (3, 4) each adjoin, via a region (13) that forms the grip tab, tear-off sections (14), the tear-off sections (14) being separable from the respective film (2, 3, 4).

11. The wafer sachet (1) of claim 10, characterized in that recesses (16) which are flush with one another are located within the tear-off sections (14) for receiving a holding rivet in a secondary pack.

12. The wafer sachet (1) of claim 1, characterized in that the first and second sealing films (3, 4) and also the peeling film (2) are each formed of a laminate of plies which are connected to one another.

13. The wafer sachet (1) of claim 1, characterized in that the first and second sealing films (3, 4) are not removable from one another.

14. The wafer sachet (1) of claim 1, characterized in that the first and second sealing films (3, 4) are each formed, on the sides which come into contact with the wafer (8), by Barex plies.

15. The wafer sachet (1) of claim 1, characterized in that the first sealing film (3) and the peeling film (2) are each connected to one another via polyethylene plies.

16. The wafer sachet (1) of claim 14, characterized in that the Barex ply and the polyethylene ply of the first sealing film (3) are connected to one another via an aluminum foil.

17. The wafer sachet (1) of claim 1, characterized in that the second sealing film (4) and the peeling film (2), on the sides which face outward, each have a printable polymer ply.

18. The wafer sachet (1) of claim 16, characterized in that the printable polymer ply of the second sealing film (4) and the printable polymer ply of the peeling film (2) consist of polyethylene terephthalate.

19. The wafer sachet (1) of claim 17, characterized in that the Barex ply and the printable polymer ply of the second sealing film (4) are connected to one another via an aluminum foil.

20. The wafer sachet (1) of claim 17, characterized in that the polyethylene ply and the printable polymer ply of the peeling film (2) are connected to one another via an aluminum foil.

21. The wafer sachet (1) of claim 1, characterized in that the wafer sachet (1) contains a wafer (8).

22. The wafer sachet (1) of claim 21, characterized in that the wafer (8) comprises drugs for contraception or for hormone replacement therapy.
